(19) United States
(12) Patent Application Publication
(10) Pub. No.: US 2003/0081269 A1
(43) Pub. Date: May 1, 2003

(54) Image reading apparatus

(75) Inventors: Takeshi Aoyama, Chiba (JP); Takayuki Suga, Ibaraki (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/277,979

(22) Filed: Oct. 23, 2002

(30) Foreign Application Priority Data
Oct. 30, 2001 (JP) 2001-332484

(51) Int. Cl. H04N 1/04

(52) U.S. Cl. 358/474; 358/486

(57) ABSTRACT

An image reading apparatus includes a second image reader reading the back of an original in an original reader, and is capable of alleviating the impact acting on the second image reader upon opening/closing of the original reader. The image reading apparatus also improves the opening/closing operability and permits easy placement of the original on the reading section. The image reading apparatus includes a line sensor which reads originals on original tables, an original feeding unit which conveys the original onto the original table, a hinge section which rotatably supports the original feeding unit relative to the apparatus main body, and a contact-type image sensor which is provided on the original feeder and reads the back of the original. The rotation axis of the hinge section is arranged so as to be perpendicular to the arrangement direction of the line sensor. A contact-type image sensor is attached to the original feeding unit via elastic members.

### BACKGROUND OF THE INVENTION

1. Field of the Invention

The present invention relates to an image reading apparatus such as a copying machine, a printer, a facsimile machine, or a scanner having an automatic original conveying unit for reading a two-sided original, which is particularly capable of reading an image of a single two-sided original during a single run of an original conveying step.

2. Description of the Related Art

An image reading apparatus having this capability is disclosed, for example, in Japanese Patent Application Laid-Open No. 2000-201251.

More specifically, the image reading apparatus has a configuration comprising first image reading means having a line sensor reading an original on an original table; original feeding means conveying the original onto the original table; and second image reading means, provided in the original feeding means, having a line sensor which reads an image on the side opposite to the image read by the first image reading means of the original conveyed by the original feeding means.

An image of the original is read by using the shorter-side direction of the largest readable original as an arrangement direction of the line sensors (main scanning direction), and using the longitudinal direction of the largest readable original as a scanning position of the line sensor, or as a conveying direction of the original (sub-scanning direction). This permits reading with line sensors of a smaller number of pixels than in a case where the longitudinal direction is used as the main scanning direction.

When cleaning the original table, correcting a paper jam of the original in conveyance, or placing the original on the original table, it is the usual practice to adopt a configuration in which the original feeding unit is made operable by providing rotary supporting means which rotatably supports the original feeding means relative to the apparatus main body, opening the space on the original table by rotating the original feeding unit in a direction toward a longer distance from the apparatus main body, and after respective operations, causing rotation of the original feeding unit again in a reverse direction.

In an image reading apparatus having second image reading means provided on such an original feeding unit as in the conventional art, an impact, which acts on the second image reading means provided on the original feeding unit as a result of opening and closing the original feeding unit, is minimized by arranging the rotation axis of the rotary supporting means of the original feeding unit in parallel with the main scanning direction, thus reducing the amount of displacement of the second image reading means caused by the rotation of the original feeding unit, and preventing breakage or deformation of the second image reading means.

However, even by arranging the rotation axis of the original feeding means in parallel with the main scanning direction, the impact resulting from opening/closing the original feeding means cannot completely be prevented from acting on the second image reading means. When the user opens or closes the original feeding means in a manner applying a strong impact on the original feeding means, there may always be a risk of causing an inconvenience such as deformation of the reading means or an abnormal adjustment.

When the rotation axis of the original feeding means is arranged in parallel with the main scanning direction, it would be arranged in parallel with the shorter-side direction of the largest original. Therefore, assuming an operator operates the apparatus with the rotation axis of the original feeding means arranged on the deeper side, the longitudinal direction of the original is in the front deeper side, and the indexing label is more distant from the operator. On the assumption that the operator operates the apparatus with the shorter-side direction of the original on the front deeper side, the rotation axis would be located to the right or the left, thus making the opening/closing operation of the original feeding means very troublesome.

### SUMMARY OF THE INVENTION

The present invention was developed to solve the problems in the conventional art described above, and can provide an image reading apparatus, having second image reading means for reading the back of an original in original feeding means, which can alleviate the impact of opening/closing of the original feeding means acting on the second image reading means.

The present invention can also provide an image reading apparatus which improves the opening/closing operability of the original feeding means and permits placing the original easily on the reading section.

A first aspect of the invention provides an image reading apparatus comprising a main body including an original table, original feeding means for conveying an original onto the original table, first image reading means including a line sensor for reading a first side of the original on the original table, rotary supporting means for rotatably supporting the original feeding means relative to the original table, and second image reading means. The second image reading means is disposed on the original feeding means, and includes a line sensor for reading a second side of the original opposite to the first side of the original read by the first image reading means. The rotation axis of the rotary supporting means is disposed so as to be perpendicular to an arrangement direction of the line sensors of the first and the second image reading means.

According to another aspect of the invention, an image reading apparatus comprises a main body including an original table, original feeding means for conveying an original onto the original table, first image reading means including a line sensor for reading a first side of the original on the original table, rotary supporting means for rotatably supporting the original feeding means relative to the original table, and second image reading means, disposed on the original feeding means, including a line sensor for reading a second side opposite to the first side of the original read by the first image reading means. The second image reading means is attached to the original feeding means via an elastic member.

In yet another aspect of the invention, an image reading apparatus comprises a guide for guiding an original, a plurality of roller pairs for conveying the original along the guide, a first image sensor that reads a first surface of the original, a second image sensor that reads a second surface on a side of the original opposite to the first surface, an enclosure that supports the guide, the plurality of roller pairs, and the second image sensor, and a support that supports the enclosure so as to permit separation from the first image sensor. The second image sensor is supported on the enclosure via a buffer member.

In still another aspect, an image reading apparatus comprises a main body including an original table, an original feeding unit for conveying an original onto the original table, a first line sensor for reading a first side of the original on the original table, a support for rotatably supporting the original feeding unit relative to the original table, and a second line sensor disposed on the original feeding unit for reading a second side of the original opposite to the first side of the original read by the first line sensor. The rotation axis of the support is disposed so as to be perpendicular to an arrangement direction on the first and the second line sensors.

Further objects, features and advantages of the present invention will become apparent from the following description of the preferred embodiments (with reference to the attached drawings).

### BRIEF DESCRIPTION OF THE DRAWINGS

FIG. 1 is a sectional view of the image reading apparatus of a first embodiment of the present invention;

FIG. 2 is a perspective view illustrating the opening/closing operation of the image reading apparatus shown in FIG. 1;

FIG. 3 illustrates the method for fixing a contact-type image sensor of the apparatus shown in FIG. 1;

FIGS. 4A through 4C illustrate the method for fixing a contact-type image sensor of a second embodiment of the invention;

FIG. 5 is a sectional view of the image reading apparatus of a third embodiment of the invention;

FIG. 6 illustrates the method for fixing the contact-type image sensor of the apparatus shown in FIG. 5; and

FIG. 7 illustrates the method for fixing the contact-type image sensor of a fourth embodiment of the invention.

### DESCRIPTION OF THE PREFERRED EMBODIMENTS

The present invention will now be described in detail by means of embodiments shown in the drawings.

### First Embodiment

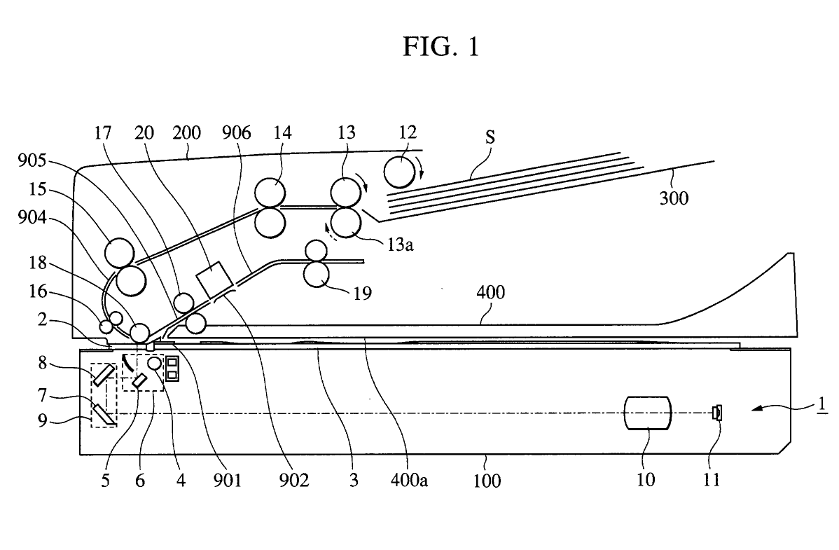

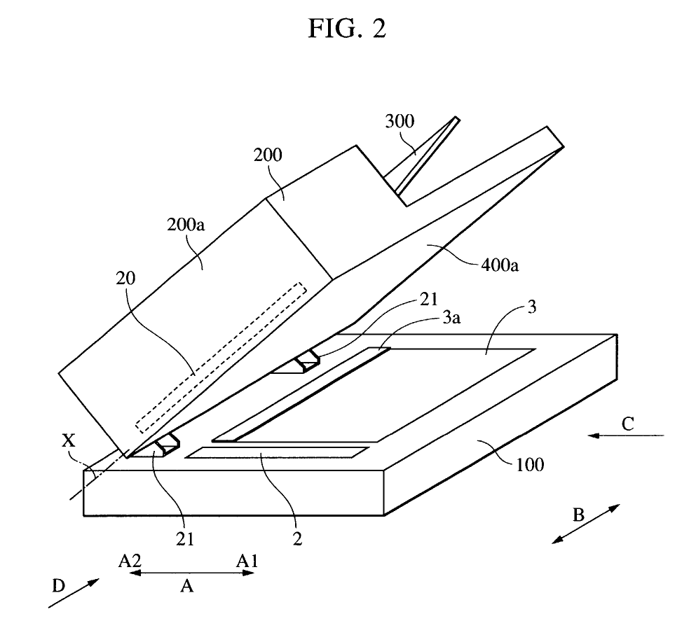

FIG. 1 is a cross-sectional view illustrating the image reading apparatus of a first embodiment of the present invention, and FIG. 2 is a perspective view thereof.

The image reading apparatus has a scanner section 100 serving as the apparatus main body, which has an original table; an original feeding unit 200 serving as original feeding means which conveys the original to the original table; and a hinge section 21 serving as rotary supporting means which rotatably supports the original feeding unit 200 relative to the scanner section 100.

The scanner section 100 has an enclosure, and a platen glass 3 for a book-type original and a platen glass 2 for a sheet-shaped original which form an original table on the upper surface of the enclosure. A first reading unit 1 serving as first image reading means having a line sensor 11 reads an original on the platen glass 3 for a book-type original and on the platen glass 2 for a sheet-shaped original. A reference white board 901 is provided on the platen glass 3 for a book-type original. Density correction of an image read by the first reading unit 1 is carried out by reading density data of this reference white board 901 by means of the line sensor 11, and generating a shading value S1 on the basis of the density data.

The first reading unit 1 has a first mirror table 6 having a lamp 4 and a first mirror 5 attached thereto; a second mirror table 9 having second and third mirrors 7 and 8 attached thereto; a lens 10; and the line sensor 11 serving as photoelectric converting means or an image sensor. The line sensor is arranged in the arrow A direction in FIG. 2.

The image of the original S on the platen glass 3 for a book-type original or the platen glass 2 for a sheet-shaped original is illuminated by the lamp 4, formed into an image through the lens 10 onto the line sensor 11 while the optical path is bent at the first, second and third mirrors 5, 7 and 8, and is read through photoelectric conversion.

The first mirror table 6 and the second mirror table 9 move at a speed ratio of 2:1 by driving means not shown. The distance between the images from the original placed on the platen glass 3 for a book-type original and the platen glass 2 for a sheet-shaped original and the line sensor 11 is therefore kept constant.

The original feeding unit 200 has a first reading unit 1 reading the original conveyed by the original feeding unit 200, and a contact-type image sensor 20 serving as second image reading means which reads an image on the side opposite to the image read by the first reading unit 1.

The original feeding unit 200 has an enclosure 200a, and a conveying system, which is supported by and housed in the enclosure, and includes the following elements: a pickup roller 12 for taking out the original S on the original tray 300 sheet by sheet; a separation roller pair 13 for preventing double-feeding of the originals; conveying roller pairs 14, 15 and 16 for introducing the original S to the platen glass 2 for a sheet-shaped original; a paper guide 904 and a relay paper guide 905; a platen roller 18 bringing the original closer to the platen glass 2 for a sheet-shaped original; a platen white board 902 for bringing the original closer to the contact-type image sensor 20; a paper discharge roller pair 19; and a paper discharge guide 906 for conveying the original to an original discharge tray 400. The contact-type image sensor 20 is provided between conveying roller pair 17 and the paper discharge roller pair 19 downstream of the platen roller 18.

The contact-type image sensor 20 comprises an LED serving as a light source not shown, a lens, and a sensor element serving as a line sensor which is photoelectric converting means. The image of the original S on the side opposite to the surface read by the line sensor 11 is read by being illuminated by a lamp in the contact-type image sensor 20 while the original S is conveyed by the original feeding unit 200, formed into an image by the lens on the sensor element, and subjected to photoelectric conversion. Density data of the platen white board 902 are read by the contact-type image sensor 20, and density of the image read by a contact-type image sensor is corrected by generating a shading value S2 on the basis of these density data.

When reading the original conveyed by the original feeding unit 200, the first and second mirror tables 6 and 9 are fixed at positions shown in FIG. 1.

When reading a book-type original or an original not permitting use of the original feeding unit 200, the original is placed on the platen glass 3 for a book-type original by rotating the original feeding unit 200 out of the way, and reading is accomplished by moving the optical system such as the first mirror table 6 and the second mirror table 9 for scanning.

The original feeding unit 200 has a function of conveying the original while pressing the same against the plate glass 2 for a sheet-shaped original serving as a reading section, and a function of covering and pressing the original on the plate glass 3 for a book-type original by means of an original pressing surface 400a under the original discharge tray 400. When cleaning the platen glass 2 for a sheet-shaped original, or correcting paper jam in the platen roller 18, the original feeding unit 200 is rotated with the hinge section 21 as the fulcrum so as to be more distant from the platen glass 3 for sheet-shaped original.

A rotation axis X, of the hinge section 21 is disposed so as to be perpendicular to the arrangement direction of the line sensor 11 of the first reading unit 1 and a line sensor (not shown) of the contact-type image sensor 20.

Operability of the apparatus will now be described with reference to FIG. 2.

An excellent opening/closing operability of the original feeding unit 200 is available in an arrangement in which, when the user operates the unit at position C (unit front) relative to the scanner section 100, the rotation axis of the hinge section 21 of the original feeding unit 200 is arranged on the deeper side (direction A2) of the unit relative to the user, and the closer side portion (direction A1) of the original feeding unit 200 is lifted. The means for starting reading operation and conducting setting of the number of sheets are therefore arranged on the assumption that the operator operates the unit at the unit front position C (closer side of the unit (direction A1)).

On the other hand, when placing the original on the platen glass 3 for a book-type original, an indexing label 3a serving as positioning means of the original relative to the platen glass 3 for a book-type original is arranged on the deeper side of the platen glass 3 for a book-type original. Since the operator conducts the operation at the unit front position C in this case, the shorter-side direction of the largest original is arranged in the front-depth direction (direction A), and the longitudinal direction is arranged in the right-left direction (direction B) so that the indexing label 3a does not part from the operator.

The operations will now be described.

When the original S is loaded on the original tray 300, the pickup roller 12 takes out the uppermost sheet in the tray, and conveys the same.

Even in a case where several sheets of original are simultaneously delivered, a retarder roller 13a provided under the separation roller pair 13 is driven so as to rotate clockwise via a torque limiter, so that the sheets of originals other than the first sheet are pushed back, and a separated one is conveyed.

The separated original sheet is then conveyed by the conveying rollers 14, 15 and 16 toward the platen roller 18 for a sheet-shaped original. Before the first sheet of the originals S passes through the reading positions of the line sensor 11 and the contact-type image sensor 20, density data of the reference white board 901 and the platen white board 902 are read, and shading values S1 and S2 are generated, respectively.

After the line sensor 11 reads the density D1 of the platen roller 18, reading of the image information of the first face is started by the passage of the first sheet of original S through the reading position of the line sensor 11.

Then, after the contact-type image sensor 20 reads the density E1 of the platen white board 902, the first sheet of the originals S is conveyed to the conveying roller pair 17, and passes through the reading position of the contact-type image sensor 20, thus causing the start of the reading of image information for the second face. The image data read by the line sensor 11 and the contact-type image sensor 20 are subjected to shading correction of image density on the basis of the shading values S1 and S2, respectively.

The original S, after the completion of reading, is conveyed by the paper discharge roller 19 to the original discharge tray 400.

Then, after reading again density D2 of the platen roller 18 and density E2 of the platen white board 902, images of the first and second faces of the second sheet of the originals S are read by the line sensor 11 and the contact-type image sensor 20. The amount of light of the lamp 4 and the lamp in the contact-type image sensor 20 varies with time. The shading of the image density of the first face of the second original S is corrected on the basis of the shading value S1 corrected in response to changes in densities D1 and D2, and on the basis of the shading value S2 corrected in response to changes in the densities E1 and E2, shading of the image density of the second original S is corrected. The same operations are repeated also for the third and subsequent sheets of the originals. After discharge of the last original sheet, the operation comes to an end.

Driving for paper feeding and conveyance is performed by a motor not shown.

The two sides of a two-side original S can thus be read during a single run of a conveying step by means of the line sensor 11 of the scanner section 100 and the contact-type image sensor 20 of the original feeding unit 200.

An example of attachment of the contact-type image sensor 20 will now be described.

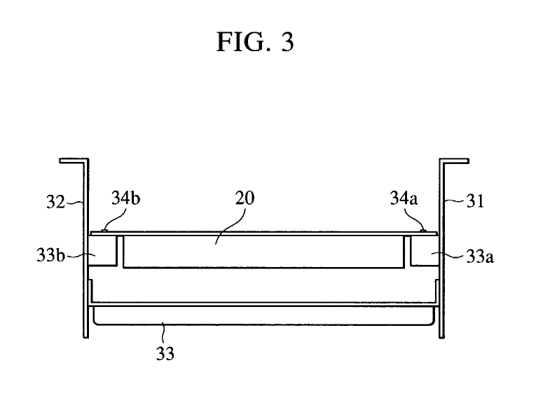

FIG. 3 is a detailed drawing of the attachment portion of the contact-type image sensor 20 provided on the original feeding unit 200 as viewed in the arrow D direction in FIG. 2.

More specifically, the contact-type image sensor 20 is attached to the original feeding unit 200 via rubber blocks 33a and 33b serving as elastic members or buffer members. A front side plate 31 and a rear side plate 32 of the original feeding unit 200 are integrally fixed by a stay 33 to form an enclosure or a frame. The rubber blocks 33a and 33b are secured with a bond to the front side plate 31 and the rear side plate 32, respectively. The contact-type image sensor 20 is fixed to the rubber blocks 33a and 33b with screws 34a and 34b.

In this embodiment, the scanner section 100 includes a reducing optical system based on the line sensor 11, and the original feeding unit 200 includes the contact-type image sensor 20. The combination may be reversed, or the scanner section 100 and the original feeding unit 200 may be the same. By fixing the rubber blocks 33a and 33b to a platen 902 in place of the front side plate 31 and the rear side plate 32, the contact-type image sensor 20 can be accurately secured to the platen white board 902. It is therefore possible to bring the original S closer to the contact-type image sensor 20 by means of the platen white board 902.

Another embodiment of the present invention will now be described. In the following paragraphs, only differences from the above-mentioned first embodiment will be described. The same component parts as in the first embodiment will be represented by the same reference numerals, omitting the description thereof.

### Second Embodiment

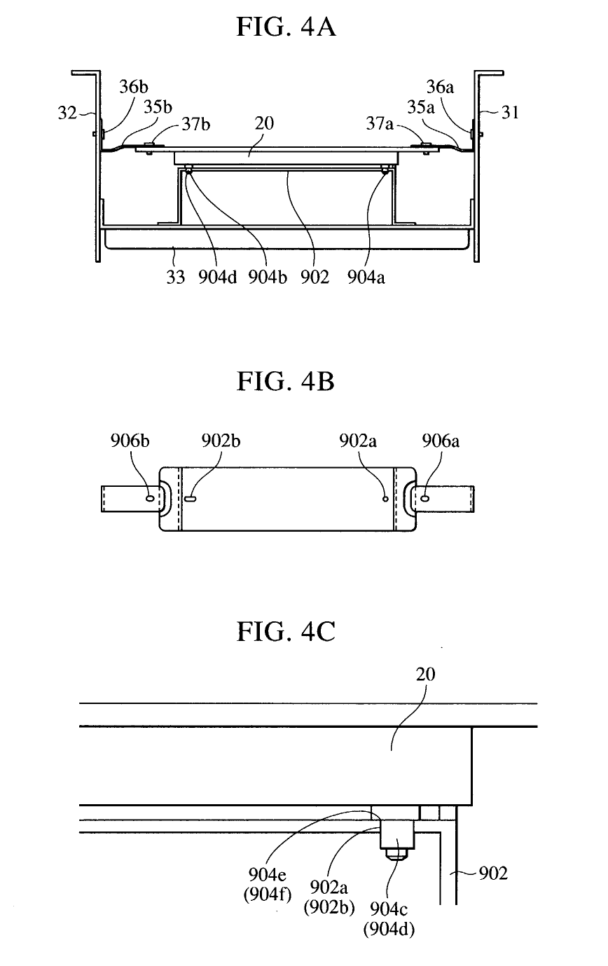

FIGS. 4A through 4C are detailed drawings of the attachment portion of the contact-type image sensor 20 in the second embodiment of the invention. FIG. 4A illustrates the platen white board 902 as viewed from below.

In the second embodiment, the contact-type image sensor 20 is attached to the original feeding unit 200 via the leaf springs 35a and 35b serving as elastic members or buffer members. A force is imparted to the contact-type image sensor 20 by the leaf springs 35a and 35b so as to hit the platen white board 902 via stepped shafts 904a and 904b. The stepped shafts 904a and 904b are secured to the contact-type image sensor 20. Small-diameter portions 904c and 904d at the leading ends of the stepped shafts 904a and 904b engage with holes 902a and 902b formed in the platen white board 902 and shoulders 904e and 904f hit and are in contact with the platen white board. The contact-type image sensor 20 can therefore be fixed to the platen white board 902, irrespective of the accuracy of the leaf springs. To cope with expansion of the contact-type image sensor caused by the heat of a built-in LED and the line sensor, the contact-type sensor 20 is fixed through long holes 906a and 906b formed at each end of each of the leaf springs 35a and 35b via stepped screws 37a and 37b, and the each end of each of the leaf springs 35a and 35b are fixed to the front side plate 31 and the rear side plate 32 by screws 36a and 36b, respectively. In this embodiment, the contact-type image sensor 20 is always positioned relative to the platen white board 902, irrespective of the deflection of the leaf springs 35a and 35b. It is therefore possible to certainly bring the original closer to the contact-type image sensor 20 by means of the platen white board 902. It is needless to mention that, also by providing long holes in the stay 33, it is possible to accurately secure the contact-type image sensor 20, irrespective of the deflection of the leaf springs 35a and 35b.

### Third Embodiment

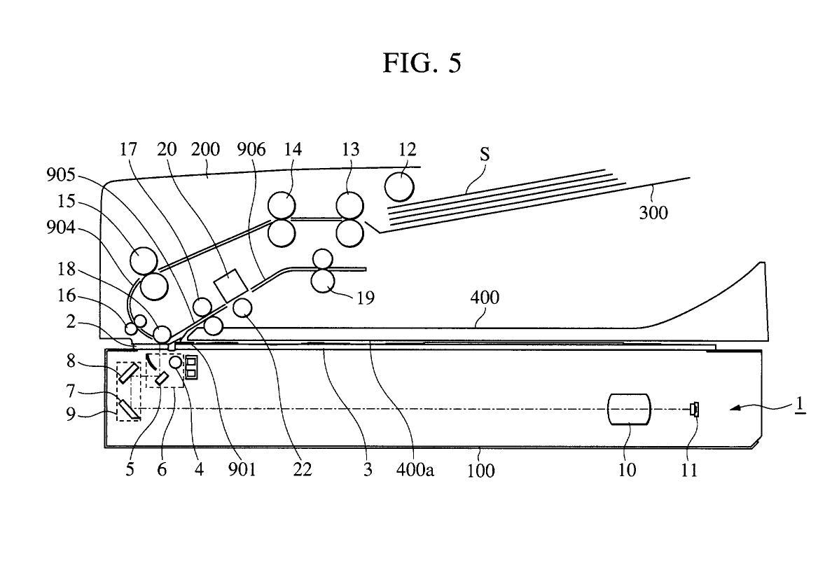

FIG. 5 is a detailed drawing of the attachment portion of the contact-type image sensor 20 in a third embodiment of the invention.

In this third embodiment, a second platen roller 22 is added at a position opposite to the contact-type image sensor 20 provided on the original feeding unit 200 of the first embodiment.

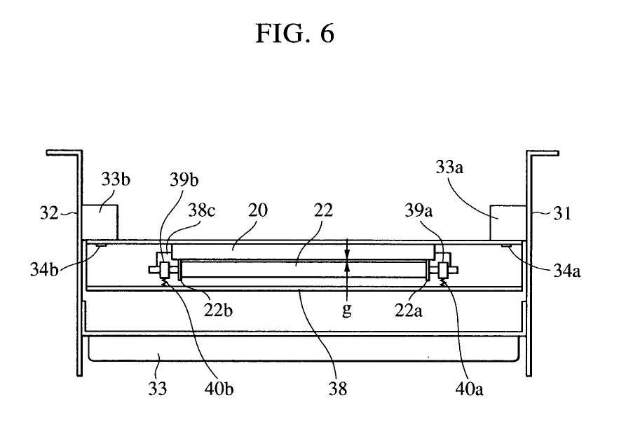

FIG. 6 illustrates details of the attachment portion of the contact-type image sensor 20 and a second platen roller 22. The second platen roller 22 is attached to the original feeding unit 200 via rubber blocks 33a and 33b serving as elastic members.

The front side plate 31 and the rear side plate 32 are integrally fixed by the stay 33 to form an enclosure, and the rubber blocks 33a and 33b are secured by a bond to the front side plate 31 and the rear side plate 32.

The contact-type image sensor 20 is fixed to a holder 38. A second platen roller 22 is supported movably in directions coming into contact with and being spaced apart from the contact-type image sensor 20 by the holder 38 via bearings 39a and 39b. Flange sections 22a and 22b provided at both ends of the second platen roller 22 are brought into pressure-contact with the contact-type image sensor 20 by compression springs 40a and 40b. In this configuration, therefore, a gap g is certainly formed between the second platen roller 22 and the contact-type image sensor 20, ensuring certain contact between the original S and the contact-type sensor 20. An opening 38c for passage of the original S is provided in the holder 38 which is secured to the rubber blocks 33a and 33b with screws 34a and 34b.

In this configuration, a high-quality read image is free from out-of-focus defects even upon occurrence of deformation of the rubber blocks 33a and 33b, because it is possible to bring the original S to the contact-type image sensor 20 by the second platen roller 22. The hardness of the rubber blocks 33a and 33b is set so as to cause a deformation within a range permitting conveyance of the original S without suffering from inconveniences such as a paper jam. By fixing the rubber blocks 33a and 33b to a relay paper guide 905 or a discharge paper guide 906 in place of the front side plate 31 and the rear side plate 32, it is possible to accurately fix the contact-type image sensor 20 to the relay paper guide 905 or the paper discharge guide 906. It is thus possible to conduct exchange with the relay paper guide 905 or the paper discharge guide 906 certainly without the risk of occurrence of a paper jam of the original S.

### Fourth Embodiment

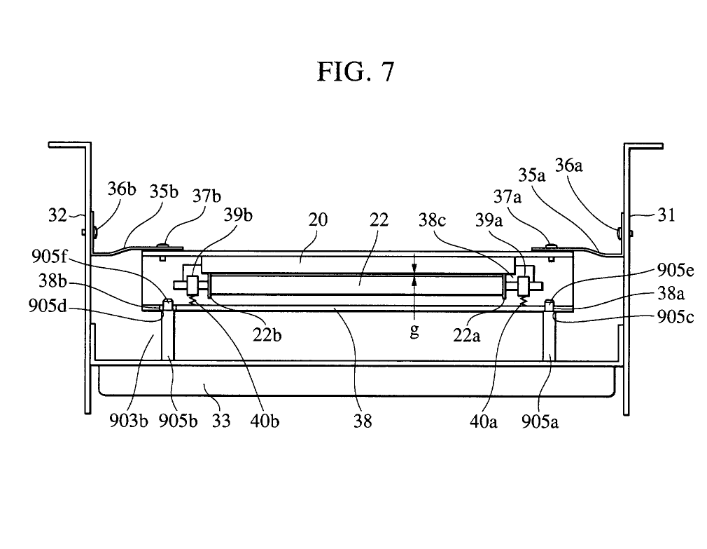

FIG. 7 is a detailed drawing of the attachment portion of the contact-type image sensor 20 of a fourth embodiment of the invention.

In this fourth embodiment, the leaf springs 35a and 35b are used in place of the rubber blocks in the third embodiment. More specifically, the contact-type image sensor 20 is attached to the original feeding unit 200 via the leaf springs 35a and 35b serving as elastic members. A holder 38, to which the contact-type image sensor 20 is fixed, hits shoulders 905c and 905d of stepped shafts 905a and 905b, which are fixed to the stay 33 by the leaf springs 35a and 35b, and holes 38a and 38b formed in the holder 38 engage with small-diameter portions 905e and 905f at the leading ends of the stepped shafts 905a and 905b. The holder 38 is secured through long holes 906a and 906b formed at each end of each of the leaf springs 35a and 35b via stepped screws 37a and 37b. Each end of each of the leaf springs 35a and 35b are fixed by a screw 36a and 36b to the front side plate 31 and the rear side plate 32, respectively. In this embodiment, the contact-type image sensor 20 is always positioned relative to the stay 33, irrespective of the deflection of the leaf springs 35a and 35b. It is therefore possible to certainly conduct exchange with the relay paper guide 905 or the paper discharge guide 906 without the risk of occurrence of a paper jam of the original S. It is possible to accurately fix the contact-type image sensor 20, not depending upon deflection of the leaf springs 35a and 35b also by providing the stepped shaft in the relay paper guide 905 or the paper discharge guide 906.

In the aforementioned embodiments, the rotation axis X of the hinge section 21 is provided so as to be perpendicular to the arrangement direction of the line sensor 11 of the first reading unit 1 and the line sensor provided on the contact-type image sensor 20. When absorbing the impact by supporting the contact-type image sensor 20 provided on the original feeding unit 200 by an elastic member such as rubber, it is not always necessary to provide the rotation axis X of the hinge section 21 so as to be perpendicular to the arrangement direction of the line sensor 11 of the first reading unit 1 and the line sensor of the contact-type image sensor 20. In some cases, the rotation axis X may be provided in parallel with the arrangement direction of the line sensors.

In the above-mentioned embodiment, the first image reading means reads the image of the original on the platen by moving the optical system. A configuration may be adopted, in which the image is read by moving the image sensor along the platen.

In the first aspect of the invention, as described above, there is provided an image reading apparatus having second image reading means for reading the back of an original in the original feeding means, wherein the rotation axis of the original feeding means is arranged on the deeper side of the apparatus relative to the user, by arranging the rotation axis of the original feeding means in a direction perpendicular to the arrangement direction of the line sensors reading the image, and it is possible to arrange the shorter-side direction of the largest original placed on the reading section of the apparatus in the front-depth direction. It is therefore possible to improve opening/closing operability of the original feeding means, and easily place the original on the reading section.

According to the second aspect of the invention, a high and stable image reading quality can be assured without the risk of deformation of the reading means or occurrence of inconveniences such as abnormal adjustment even when the user conducts opening/closing which gives a strong impact on the original feeding means, by supporting the second image reading means provided on the original feeding means by an elastic member such as rubber, in addition to the above-mentioned arrangement of the rotation axis of the original feeding means.

According to the third aspect of the invention, a high and stable image reading quality can be assured without the risk of deformation of the reading means or occurrence of inconveniences such as abnormal adjustment even when the user conducts opening/closing which gives a strong impact on the original feeding means, by supporting the second image reading means provided on the original feeding means by an elastic member such as rubber, irrespective of the arrangement of the rotation axis of the original feeding means.

According to the fourth and fifth aspects of the invention, the impact on the second image reading means can be alleviated in a very simple configuration, by adopting a rubber material or a leaf spring as the elastic member.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An image reading apparatus comprising:
a main body comprising an original table;
original feeding means for conveying an original onto said original table;
first image reading means comprising a line sensor for reading a first side of the original on said original table;
rotary supporting means for rotatably supporting said original feeding means relative to said original table; and
second image reading means, disposed on said original feeding means, comprising a line sensor for reading a second side of the original opposite to the first side of the original read by said first image reading means,
wherein the rotation axis of said rotary supporting means is disposed so as to be perpendicular to an arrangement direction of the line sensors of said first and said second image reading means.

2. An image reading apparatus according to claim 1, wherein said second image reading means is attached to said original feeding means via an elastic member.

3. An image reading apparatus comprising:
a main body comprising an original table;
original feeding means for conveying an original onto said original table;
first image reading means comprising a line sensor for reading a first side of the original on said original table;
rotary supporting means for rotatably supporting said original feeding means relative to said original table; and
second image reading means, disposed on said original feeding means, comprising a line sensor for reading a second side opposite to the first side of the original read by said first image reading means,
wherein said second image reading means is attached to the original feeding means via an elastic member.

4. An image reading apparatus according to claim 2 or 3, wherein said elastic member is made of rubber.

5. An image reading apparatus according to claim 2 or 3, wherein said elastic member is a leaf spring.

6. An image reading apparatus according to claim 1 or 3, wherein said original feeding means comprises a plurality of roller pairs and a guide for guiding the original.

7. An image reading apparatus according to claim 1 or 3, wherein said rotary supporting means comprises a hinge.

8. An image reading apparatus comprising:
a guide for guiding an original;
a plurality of roller pairs for conveying the original along said guide;
a first image sensor that reads a first surface of the original;
a second image sensor that reads a second surface on a side opposite to the first surface;
a frame that supports said guide, said plurality of roller pairs, and said second image sensor; and
support that supports said frame so as to permit separation from said first image sensor;
wherein said second image sensor is supported on said frame via a buffer member.

9. An image reading apparatus according to claim 8, further comprising a platen glass and a pressing surface disposed on said frame for pressing the original placed on said platen glass, wherein said first image sensor reads the image of the original placed on said platen glass.

10. An image reading apparatus according to claim 9, further comprising an optical system that forms an image of the original on said first image sensor by scanning the original on said platen glass.

11. An image reading apparatus according to claim 8 or 9, wherein said buffer member is an elastically deformable member.

12. An image reading apparatus according to claim 8 or 9, wherein said buffer member is a rubber member.

13. An image reading apparatus according to claim 8 or 9, wherein said buffer member is a leaf spring.

14. An image reading apparatus according to claim 8, wherein said support rotatably supports said frame.

15. An image reading apparatus according to claim 8, further comprising a second frame that supports said first image sensor.

16. An image reading apparatus according to claim 15, wherein said second frame has a platen glass adapted support the original, and said first image sensor is adapted to read the original placed on said platen glass.

17. An image reading apparatus according to claim 16, wherein said support rotatably supports said frame on said second frame.

18. An image reading apparatus according to claim 17, wherein a pressing surface for pressing the original placed on said platen glass is disposed on said frame.

19. An image reading apparatus according to claim 16, wherein said first image sensor is adapted to either (i) read the original after the original is conveyed to a predetermined position by said plurality of conveying roller pairs and stopped, or (ii) read the original while the original is moved along said platen glass.

20. An image reading apparatus comprising:
a main body comprising an original table;
an original feeding unit for conveying an original onto said original table;
a first line sensor for reading a first side of the original on said original table;
a support for rotatably supporting said original feeding unit relative to said original table; and
a second line sensor disposed on said original feeding unit for reading a second side of the original opposite to the first side of the original read by said first line sensor,
wherein the rotation axis of said support is disposed so as to be perpendicular to an arrangement direction of said first and said second line sensors.

21. An image reading apparatus according to claim 20, wherein said second line sensor is attached to said original feeding unit via an elastic member.

22. An image reading apparatus according to claim 21, wherein said original feeding unit includes a platen roller disposed opposite to said second line sensor, said platen roller including flange sections at each end, the flange sections biased by compression springs and brought into contact with said second line sensor.

23. An image reading apparatus according to claim 22, wherein said elastic member is rubber, and a hardness of said elastic member is determined so as to allow a deformation within a predetermined range when the original is fed through said original feeding unit.

24. An image reading apparatus according to claim 21, wherein said original feeding unit includes a holder, said holder is affixed to said elastic member which is affixed to said original feeding unit, and said second line sensor is affixed to said holder.
